(19) United States
(12) Patent Application Publication
(10) Pub. No.: US 2025/0375734 A1
(43) Pub. Date: Dec. 11, 2025

(54) METHOD AND SYSTEM FOR GAS TREATMENT AND PURIFICATION USING MODIFIED ADVANCED OXIDIZING TECHNOLOGY

(71) Applicants: Apichet PONGLIKHITTANON, Chonburi (TH); Korada SUPAT, Chonburi (TH)

(72) Inventors: Apichet PONGLIKHITTANON, Chonburi (TH); Korada SUPAT, Chonburi (TH)

(21) Appl. No.: 18/878,587

(22) PCT Filed: Jun. 22, 2023
(86) PCT No.: PCT/TH2023/050011

§ 371 Date: Dec. 23, 2024

Related U.S. Application Data
(60) Provisional application No. 63/354,984, filed on Jun. 23, 2022.

(51) Int. Cl. B01D 53/72; B01D 53/78

(52) U.S. Cl. CPC B01D 53/72; B01D 53/78; B01D 2251/104; B01D 2257/708

(57) ABSTRACT

A method for gas treatment and purification. The method comprises generating ozone from a supply of gas comprising an oxygen (O2) gas in presence of a defined voltage, oxidizing the ozone (O3), in an oxidization chamber, in presence of light of a pre-defined wavelength and at least one oxidation catalyst to generate reactive oxygen species (ROS), feeding, in a first reactive space, the generated reactive oxygen species and a feed gas that is to be treated and purified and producing, from the first reactive space, a first treated gas from a reaction of the feed gas and the generated reactive oxygen species. The method for gas treatment and purification provides an efficient, robust, environmentally friendly, energy-saving, and cost-efficient gas treatment and purification process.

### TECHNICAL FIELD

The present disclosure relates generally to the field of gas treatment and purification and, more specifically, to a method for gas treatment and purification and a system for gas treatment and purification using modified advanced oxidizing technology.

### BACKGROUND

Global industrialization has led to an increase in environmental pollution. Typically, the environmental pollution is caused by the various contaminants present in gases, such as waste gas obtained from factories, industrial facilities, and the like. Moreover, the said contaminated gases are released into environment with minimal or no prior treatment thereof, thereby driving climate change and damaging human health.

Generally, advanced oxidizing technologies are well known technologies to remove organic and inorganic substances present in a wastewater. The advanced oxidizing technologies are based on the use of hydroxyl radicals for the oxidation of organic and inorganic compounds present in the wastewater. In this regard, the organic and the inorganic compounds are converted into stable compounds, such as water, carbon dioxide, and so forth. Thereby the conversion allows the removal of the contaminants present in the wastewater. Nowadays, the advanced oxidizing technologies have begun to be applied in gas treatment and gas purification. However, the conventional advanced oxidizing technologies are limited by major factors, such as low efficiency, redundant investment cost, redundant operation cost, and therefore cannot be applied industrially on a large scale. Furthermore, the conventional advanced oxidizing technologies are not sufficient to eliminate microorganisms and achieve a high level of disinfection. Additionally, the growing need for effective disinfection techniques in various industries, such as healthcare, food processing, and environmental remediation, necessitates the development of advanced and efficient gas treatment processes. Therefore, in light of the foregoing discussion, there exists a need to overcome the aforementioned drawbacks associated with gas treatment and purification by conventional advanced oxidizing technologies.

### SUMMARY

The present disclosure provides a method for gas treatment and purification and a system for gas treatment and purification. The present disclosure provides a solution to the existing problem of how to provide an efficient, robust, environmentally friendly, energy-saving, and cost-efficient gas treatment and purification process. An objective of the present disclosure is to provide a solution that overcomes at least partially the problems encountered in the prior art and provides an improved method and system for gas treatment and purification.

One or more objectives of the present disclosure are achieved by the solutions provided in the enclosed independent claims. Advantageous implementations of the present disclosure are further defined in the dependent claims.

In one aspect, the present disclosure provides a method for gas treatment and purification, comprising:
generating ozone from a supply of gas comprising an oxygen (O₂) gas in presence of a defined voltage;
oxidizing the ozone (O₃), in an oxidization chamber, in presence of light of a pre-defined wavelength and at least one oxidation catalyst to generate reactive oxygen species (ROS);
feeding, in a first reactive space, the generated reactive oxygen species and a feed gas that is to be treated and purified; and
producing, from the first reactive space, a first treated gas from a reaction of the feed gas and the generated reactive oxygen species.

The method employs a modified advanced oxidizing technology for removing organic and/or inorganic compounds, contaminants, and odor present in the gas, such as waste gas, through reactions with reactive oxygen species (ROS) for producing the first treated gas. Moreover, the method is used for the generation of reactive oxygen species (ROS) which possess strong disinfection properties. The ROS allows for effective neutralization and destruction of microorganisms present in the gas stream, ensuring a high level of disinfection. Furthermore, the oxidation reactions activated and accelerated by the generated ROS effectively degrade organic components and contaminants in the feed gas, leading to improved gas quality. Additionally, the method can be implemented in various gas treatment systems and adapted to different scales of operation. The method offers flexibility in treating diverse types of gas streams and can be tailored to specific treatment and purification requirements, making it suitable for a range of industrial applications. Furthermore, the method allows for continuous, consistent, and uninterrupted gas treatment and purification by facilitating the feeding of the generated ROS and the feed gas into the first reactive space. Additionally, the process promotes environmental sustainability by minimizing the generation of harmful by-products.

In an implementation form, the first reactive space is a first reactor, wherein the reaction of the feed gas and the generated reactive oxygen species is in the presence of light of a pre-defined wavelength and at least one oxidation catalyst.

In such implementation, the method achieves accelerated oxidation reactions between the feed gas and the generated reactive oxygen species by utilizing a combination of the first reactor, the pre-defined wavelength light, and the at least one oxidation catalyst.

In an implementation form, the method further comprises pre-contacting the feed gas and the generated reactive oxygen species in a chamber prior to the feeding of the feed gas and the generated reactive oxygen species in the first reactive space, wherein the chamber is disposed between the oxidization chamber and the first reactive space.

In such implementation, the pre-contacting of the feed gas and the reactive oxygen species in the chamber allows for enhanced interaction therebetween before entering the first reactive space. Moreover, the pre-contacting improves mixing and well distribution of the feed gas and reactive oxygen species and ensures a more efficient and thorough gas treatment and purification.

In a further implementation form, the feed gas and the generated reactive oxygen species are separately fed via two different inlets in the first reactive space.

In such implementation, the feed gas and the generated reactive oxygen species are separately fed via two different inlets into the first reactive space to allow better control and optimization of the reaction conditions. Moreover, the method is used to provide the feed gas and the generated reactive oxygen species at a desired rate and concentration, enabling precise adjustment of the reaction parameters.

In a further implementation form, the first reactor is a packed-bed reactor.

In such implementation, the packed-bed reactors provide a large surface area for the interaction among catalyst and reactants i.e. the feed gas and the reactive oxygen species. Moreover, the packing material arranged in the packed-bed reactor creates a high contact efficiency, ensuring intimate mixing and prolonged interaction between the reactants. Thus the packed-bed reactors lead to improved reaction kinetics.

In a further implementation form, the at least one oxidation catalyst is arranged in a packed-bed reactor.

In such implementation, the method employs the at least one oxidation catalyst in the packed-bed reactor to improve the surface contact among catalyst and reactants such as the feed gas and the generated reactive oxygen species, thereby improving the reaction therebetween.

In a further implementation form, the at least one oxidation catalyst is selected from at least one transition metal oxides of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, or a lead oxide.

In such implementation, the at least one transition metal oxides exhibit excellent catalytic activity, allowing for efficient and rapid oxidation reactions. The at least one transition metal oxides provide active sites on the surfaces of the catalyst support with a high surface area. The catalyst support may be inert or participate in the catalytic reactions. Typical catalyst supports include various kinds of for example activated carbons, alumina, and ceramic to maximize the specific surface area of a catalyst. The at least one transition metal oxides promote the interaction between the reactive oxygen species and the target pollutants present in the feed gas.

In a further implementation form, the reactive oxygen species is at least one of: a superoxide anion, a hydroxyl radical, a hydroxyl ion, a peroxyl radical, an alkoxyl radical, a hydroperoxyl radical, a perhydroxyl radical, a peroxide ion, a hydrogen peroxide, a singlet oxygen.

In such implementation, the method incorporates at least one of the aforementioned reactive oxygen species having unique properties and reactivity, allowing for targeted oxidation of specific compounds present in the feed gas. The versatility enables the system to effectively treat a wide range of pollutants present in the feed gas.

In a further implementation form, the method further comprises subjecting the first treated gas to at least one of: a water scrubber or an air filter, for removing one or more contaminants from the first treated gas.

In such implementation, the method employs the water scrubber or the air filter for separating the dissolvable components such as nitrate (NO₃), sulfur trioxide (SO₃), sulfate (SO₄), oxide of metal contaminants, and so forth from the first treated gas.

In a further implementation form, the method further comprises feeding the first treated gas obtained from the first reactive space, into a second reactive space, wherein the second reactive space is disposed after the first reactive space and producing a second treated gas from the second reactive space by causing the first treated gas to react in presence of the light of the pre-defined wavelength and at least one reduction catalyst in the second reactive space.

In such implementation, the method employs the second reactive space for further treatment of the first treated gas in order to produce the second treated gas containing more stable and less harmful chemical compounds, for example, oxides of nitrogen (NOx) to non-toxic products like nitrogen (N2).

In a further implementation form, the at least one reduction catalyst provided in the second reactive space is selected from at least one of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide, a barium oxide, a lithium oxide, a calcium oxide, a potassium oxide, a magnesium oxide, a sodium oxide.

In such implementation, the method employs the at least one reduction catalyst to reduce hazardous compounds, for example, oxides of nitrogen (NOx) to stable and less harmful products like nitrogen (N₂) and terminate the reaction of the ROS. Moreover, the at least one reduction catalyst is used in the second reactive space to provide an efficient reduction of pollutants, enhanced reactivity, wide applicability, and stability of the method, thereby providing a cleaner and healthier environment.

In another aspect, the present disclosure provides a system for gas treatment and purification. The system comprises a supply arrangement to provide a supply of gas comprising an oxygen (O₂) gas, a voltage source, operatively coupled to the supply arrangement, to subject a defined voltage to the supply of gas comprising the oxygen (O₂) gas to generate ozone (O₃), an oxidization chamber configured to oxidize the ozone to generate a reactive oxygen species (ROS) in presence of ultraviolet (UV) light of a pre-defined wavelength and at least one oxidation catalyst and a first reactive space, operatively coupled to the supply arrangement and the oxidization chamber, is configured to receive a feed gas and the generated reactive oxygen species and produce a first treated gas from a reaction of the feed gas and the generated reactive oxygen species in presence of the at least one oxidation catalyst.

The system achieves all the advantages and technical effects of the method of the present disclosure.

It is to be appreciated that all the aforementioned implementation forms can be combined.

It has to be noted that all devices, elements, circuitry, units, and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity that performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a flowchart of a method for gas treatment and purification, in accordance with an embodiment of the present disclosure;

FIG. 2 is a schematic diagram of a system for gas treatment and purification, in accordance with an embodiment of the present disclosure;

FIG. 3 is a graphical representation of measured values of the concentration of the chemical compounds present in a feed gas and a first treated gas, in accordance with an embodiment of the present disclosure; and

FIG. 4 is a graphical representation of measured values of the concentration of the volatile organic compounds (VOCs) present in a feed gas and a first treated gas, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

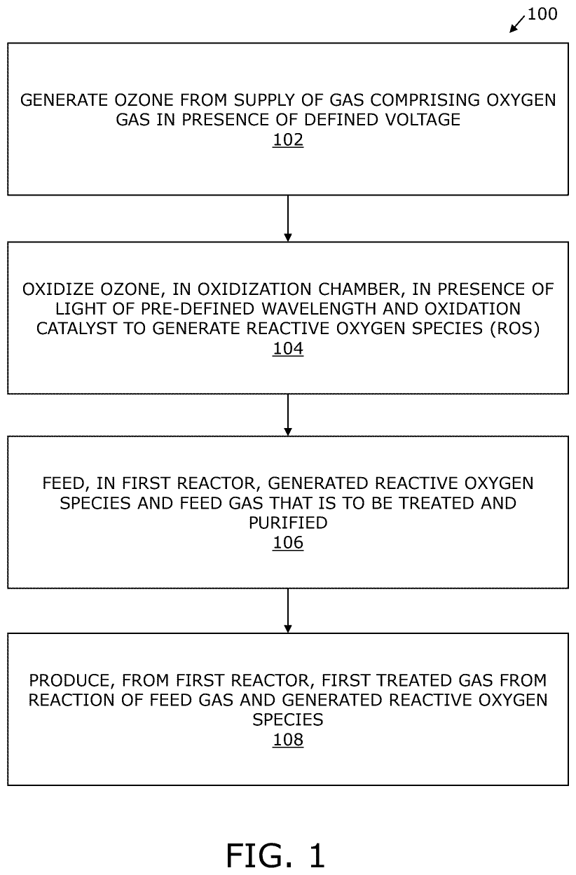

FIG. 1 is a flowchart of a method for gas treatment and purification, in accordance with an embodiment of the present disclosure. With reference to FIG. 1, there is shown a flowchart of a method 100 for gas treatment and purification. The method comprises steps 102 to 108.

There is provided the method 100 for gas treatment and purification. The method 100 is used to treat and/or purify the gas. In an example, the gas is a contaminated gas, a waste gas obtained from a factory or an industrial facility before release thereof into an environment. The gas treatment refers to processes and means by which the gas from any sources, such as gas emissions from waste disposal are converted into less harmful substances, for example, converting of hydrogen sulfide (H₂S) and thioformaldehyde CH₂S in the waste gas to carbon dioxide (CO₂), hydrogen (H₂) and Sulphur(S). The gas purification refers to processes and means in which the impurities in the gas from any sources are removed or converted. For example, removing or converting particulate matter (i.e., PM 2.5) from the atmosphere in a closed space such as a building. In an implementation, the method 100 supports disinfection of the gas. The disinfection refers to processes and means of destroying pathogenic microorganisms in order to interrupt the infection transmission mechanism by disinfecting various objects, for example, destroying pathogenic microorganisms on surface of fruits. In an implementation, the method 100 supports sanitization of the gas. The sanitization refers to processes and means of making a subject sanitary (e.g., free of germs), for example, sanitization of an operating room.

In an implementation, the method 100 includes, using a modified advanced oxidizing technology for gas treatment and purification. The advanced oxidizing technology (or advanced oxidation process) refers to a chemical treatment technology that employs advanced oxidization processes for removing organic and/or inorganic compounds through reactions with hydroxyl radicals, especially in water and wastewater treatment and purification. The modified advanced oxidizing technology has been developed for effective gas and waste gas treatment and purification through reactions of feed gas with the radical oxygen species.

At step 102, the method 100 comprises generating ozone from a supply of gas. The supply of gas includes an oxygen (O₂) gas in the presence of a defined voltage. In an implementation, the supply of gas is provided through a supply arrangement. Moreover, the supply arrangement may be a gas cylinder, a gas well, or a network of pipelines to provide a continuous supply of the gas. The supply arrangement enables an efficient and improved control over a pressure of the gas, thereby allowing a safe and economical supply of the gases. Furthermore, a voltage source is operatively coupled to the supply arrangement in order to provide the defined voltage to the supply of gas. In an example, the defined voltage is in a range from 34 kilovolts (kV) to 12 kilovolts (kV) to ensure the efficient production of ozone. In an implementation, the method 100 may involve using an ozone generator to apply the defined voltage to the oxygen gas, causing the oxygen gas to undergo a chemical reaction and form ozone molecules (O₃).

At step 104, the method 100 comprises oxidizing the ozone in an oxidization chamber. In this regard, the oxidization chamber includes a light source that emits light of the pre-defined wavelength. In an implementation, the wavelength is pre-defined based on the desired reaction conditions and the characteristics of the at least one oxidation catalyst used. It will be appreciated that the pre-defined wavelength is chosen to optimize the energy absorption and activation of the ozone molecules, promoting the conversion of the ozone molecules into the reactive oxygen species. In an example, the oxidization chamber may be a hermetically sealed chamber. Moreover, the oxidization chamber includes an inlet configured to receive the supply of gas comprising ozone (O₃) into the oxidization chamber. Furthermore, the light source is configured to output the ultraviolet (UV) light of the pre-defined wavelength. In accordance with an embodiment, the light of the pre-defined wavelength is an ultraviolet (UV) light. In an implementation, the pre-defined wavelength of the ultraviolet (UV) light may range from 10 nm to 400 nm. In addition, the at least one oxidation catalyst refers to a catalyst that causes oxidation reactions. It will be appreciated that the at least one oxidation catalyst is an active site to accelerate the reaction by decreasing the activation energy of each reaction. Optionally, a catalyst support is the part where the at least one oxidation catalyst is attached (affixed) by increasing the surface contact of the at least one oxidation catalyst. In this regard, the at least one oxidation catalyst enables the transfer of oxygen atoms, hydrogen atoms, or electrons, during the reaction.

In an implementation, the combination of the pre-defined wavelength light and the at least one oxidation catalyst creates an environment that promotes the efficient conversion of ozone into the reactive oxygen species. In accordance with an embodiment, the at least one oxidation catalyst is selected from at least one transition metal oxides of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide. The technical effect of including the transition metal oxides as the at least one oxidation catalyst is to enhance the efficiency of the oxidation process within the oxidization chamber. Typically, the at least one transition metal oxides exhibit high catalytic activity, promoting the conversion of ozone into the reactive oxygen species. The at least one transition metal oxides provide active site for the adsorption and activation of ozone molecules, leading to the decomposition of the ozone molecules and the generation of the reactive oxygen species.

The reactive oxygen species refers to highly reactive chemicals formed from oxygen. Typically, the reactive oxygen species operate via one-electron oxidation (radical ROS species) or two-electron oxidation (non-radical ROS species).

In accordance with an embodiment, the reactive oxygen species is at least one of: a superoxide anion, a hydroxyl radical, a hydroxyl ion, a peroxyl radical, an alkoxyl radical, a hydroperoxyl radical, a perhydroxyl radical, a peroxide ion, a hydrogen peroxide, a singlet oxygen. In an implementation, the reactive oxygen species are mainly oxidizing agents that can oxidize other chemical elements by accepting the electrons therefrom. It will be appreciated that the reactive oxygen species support disinfecting the feed gas by neutralizing or destroying microorganisms, such as bacteria, viruses, and fungi present therein. In an implementation, the reactive oxygen species may act as a reducing agent as well depending upon the oxidation state thereof. Furthermore, the superoxide anion (O₂·₋) is produced by the one-electron reduction of molecular oxygen. Moreover, in aqueous media, protonation of superoxide can form the uncharged hydroperoxyl radical (HOO⋅). In addition, the superoxide anion is used to provide a readily available source of oxygen and is an improved reducing agent as compared to an oxidizing agent. The hydrogen peroxide is a closed-shell molecule resulting from the one-electron reduction of O₂·₋. The singlet oxygen refers to a gaseous inorganic chemical with the formula O═O (¹O₂). The singlet oxygen is a strong oxidant and is far more reactive toward organic compounds. Furthermore, the peroxy radicals possess a low oxidizing ability as compared to hydroxyl radical but include a high diffusibility of the reactant molecules in the catalytic reaction. Additionally, the alkoxyl radicals have intermediate reactivity between the hydroxyl radical and the peroxy radical. Typically, superoxide (O₂·₋), hydroxyl (OH·), peroxyl (RO₂·), alkoxyl (RO·), hydroperoxyl (HO₂·), nitric oxide (NO^{·}) and nitrogen dioxide (NO₂^{·}) are the radical species. Typically, hydrogen peroxide (H₂O₂), hypochlorous acid (HOCl₋), ozone (O₃), singlet oxygen (¹O₂), peroxynitrite (ONOO₋), alkyl peroxynitrites (ROONO), dinitrogen trioxide (N2O3), dinitrogen tetroxide (N₂O₄), nitrous acid (HNO₂), nitronium anion (NO₂₊), nitoxyl anion (NO⁻), nitrosyl cation (NO⁺), and nitryl chloride (NO₂Cl) are the non-radical species. Additionally, the oxidization chamber includes an outlet to output the generated reactive oxygen species.

The generated ROS can be used by spraying on surfaces that need to be disinfected, such as on the surface of fruit peels, causing the fruit to be stored for longer or eliminating odors in containers, for disinfection in a closed system or air purification in a closed system. This is performed on air in a closed system in the same way that the feed gas reacts with ROS and circulate treated gas into the closed system again. In addition, it may be used in the event that the air outside need to be treated. The air outside is regarded as a feed gas that is received to react with the ROS and the treated gas is delivered to Aeration in a closed system. In an implementation, for surface disinfection of specific areas, for example, on the surface of the fruit peel in order to prolong shelf life of the fruits such as an apple and an orange, and on surface of container for deoderization, the generated reactive oxygen species may be directly sprayed therein. In an implementation, for fumigation of a closed system, for example, a clean room, a classroom, and a container, such as the generated reactive oxygen species shall be combined with air circulation system herein.

In accordance with an embodiment, the method 100 further comprises pre-contacting the feed gas and the generated reactive oxygen species in a chamber. The chamber refers to a process vessel that is used for carrying out various operations, such as the mixing of reactants therein. Moreover, the chamber is disposed between the oxidization chamber and the first reactive space. In an operation, the feed gas and the generated reactive oxygen species are fed prior to feeding thereof in the first reactive space. It will be appreciated that the pre-contacting improves the efficiency of the gas treatment and purification in some cases. For example, the pre-contacting may improve the efficiency of gas treatment and purification when the at least one oxidation catalyst is not applied in the first reactive space. It will be appreciated that ROS and feed gas are fed separately into the first reactive space in the presence of catalyst and UV due to the fact that ROS is still more active when reacted under the catalyst and the UV in the first reactive space, resulting in a purified treated gas.

However, in the absence of catalyst and UV in the first reactive space, pre-contacting would be preferable as it facilitates the mixing of the materials, and allowing ROS and feed gas to react well and increasing the residence time, including longer reaction time.

At step 106, the method 100 comprises feeding, in a first reactive space, the generated reactive oxygen species and a feed gas that is to be treated and purified. The first reactive space as used herein refers to a process vessel that is used to carry out a chemical reaction under appropriate process variables. The first reactive space is designed to facilitate the reaction between the reactive oxygen species and the pollutants or contaminants present in the feed gas. Firstly, the feed gas is fed in the first reactive space. In an example, the feed gas includes compounds, such as volatile organic compounds (VOC), hydrocarbon compounds, sulfur compounds, and so forth, aimed for treatment and/or purification. Furthermore, the generated reactive oxygen species, obtained from the oxidization chamber, is fed into the first reactive space. In an implementation, the reactive oxygen species is fed into the first reactive space together with the feed gas (e.g., contaminated air in the room), which is sucked from a closed environment (e.g., a room) in order to achieve an efficient and good circulation of the clean air in the closed environment. In an implementation, the reactive oxygen species is fed into the first reactive space together with the feed gas e.g. contaminated air from outside of the closed system, which is sucked from the environment in order to obtain clean air for uptaking into the closed system.

In accordance with an embodiment, the first reactive space is a first reactor, such as the reaction of the feed gas and the generated reactive oxygen species in the presence of the light of a pre-defined wavelength and the at least one oxidation catalyst. Herein, the first reactor refers to a dedicated chamber or vessel designed to facilitate the reaction between the feed gas and the generated reactive oxygen species. In an implementation, the first reactor provides a controlled environment for the reaction to occur efficiently. It will be appreciated that the first reactor, the light of the pre-defined wavelength, and at least one oxidation catalyst work in conjunction with each other to provide an optimized environment for the reaction between the generated reactive oxygen species and the feed gas. The light energy promotes the activation of the generated reactive oxygen species, accelerating the oxidation reactions and improving the kinetics of the process. In another implementation, the first reactor, the light of the pre-defined wavelength, and at least one oxidation catalyst work in conjunction with each other to allow for the customization of the method 100 to address specific pollutant removal requirements. Beneficially the use of the at least one oxidation catalyst in the first reactive space is to enhance the rate of oxidation and yield of the desired reaction by reducing the activation-energy of the desired reaction pathway.

In accordance with an embodiment, the first reactor is a packed-bed reactor. Herein, the packed-bed reactor refers to a column or vessel filled with solid particles or catalysts. In accordance with an embodiment, the at least one oxidation catalyst is arranged in the packed-bed reactor. Moreover, the method employs the packed-bed reactor for allowing efficient mass transfer and diffusion of reactants, such as the generated reactive oxygen species and the feed gas. In this regard, the at least one oxidation catalyst serves as a medium to promote the reaction between the generated reactive oxygen species and the pollutants or contaminants in the feed gas. Moreover, the packed-bed reactor provides a longer residence time for the feed gas and the generated reactive oxygen species therein.

In accordance with an embodiment, the feed gas and the generated reactive oxygen species are separately fed via two different inlets in the first reactive space. Beneficially, the separate feeding of the feed gas and the generated reactive oxygen species through two different inlets allows fully active reactive oxygen species to react with the feed gas under activated environment with at least one oxidation catalyst and the pre-defined wavelength of the ultraviolet (UV) light in the first reactive space. Separately feeding of the feed gas and the generated reactive oxygen species in the first reactive space provides benefits for independent adjustment of the flow rates, concentrations, and mixing ratios thereof. In an implementation, the separate inlets for the feed gas and the generated reactive oxygen species offer flexibility in process design. In an example, separate feeding allows for the ability to adjust the introduction of the feed gas and the generated reactive oxygen species independently. The flexibility enables the optimization of the method 100 for different types of feed gases and specific purification requirements.

Moreover, the first reactive space includes a packed-bed reactor including the at least one oxidation catalyst of one or more transition metal oxides. The packed-bed reactor refers to vessel packed with catalyst particles or pellets and a gas that flows through the at least one oxidation catalyst. The solid catalyst particles or pellets are used to catalyse reactions in the first reactive space. Moreover, the said reactions take place on the surface of the at least one oxidation catalyst. Advantageously, the packed-bed reactor enables higher conversion of the reactant molecules per weight of catalyst than other catalytic reactors. In operation, the at least one oxidation catalyst in a packed-bed reactor may form a structured packing in the first reactive space. In an implementation, the at least one oxidation catalyst is affixed on surface of catalyst support which is a porous material so that reaction occurs in the pores and may help to improve the reaction rate. In an operation, the at least one oxidation catalyst converts hazardous compounds, such as volatile organic compounds (VOCs), formaldehyde, and other hydrocarbons to stable and less harmful products like carbon dioxide.

At step 108, the method 100 comprises producing, from the first reactive space, a first treated gas from a reaction of the feed gas and the generated reactive oxygen species. In this regard, the first reactive space allows the reaction between the feed gas and the generated reactive oxygen species, thus facilitating the removal or reduction of pollutants, contaminants, or undesirable components present in the feed gas. As a result, the first treated gas obtained from the reaction is cleaner, lower or no from harmful substances, and more suitable for various applications. The efficient reaction mechanism reduces the residence time required for effective treatment, leading to improved process throughput and reduced energy consumption.

In an implementation, the first reactive space enables bringing the feed gas and the generated reactive oxygen species into intimate contact with active sites on the packed-bed reactor under appropriate process variables, such as temperature, pressure, flow, the concentration of reactants, and so forth, for adequate time. Furthermore, the rate of the reaction is proportional to the amount of the at least one oxidation catalyst, the reactants contact, as well as concentrations of the reactants.

In accordance with an embodiment, the method 100 further comprises pre-contacting the feed gas and the generated reactive oxygen species in a chamber prior to the feeding of the feed gas and the generated reactive oxygen species in the first reactive space, such as the chamber is disposed between the oxidization chamber and the first reactive space. In this regard, the pre-contacting step in the chamber facilitates an improved mixing and contact between the feed gas and the generated reactive oxygen species. The pre-contacting supports a higher degree of reaction between the two components, leading to improved efficiency in the method 100. Moreover, by allowing the feed gas and the generated reactive oxygen species to interact in the chamber before entering the first reactive space, any contaminants present in the feed gas are more effectively exposed to the generated reactive oxygen species.

The pre-contacting results in increased removal of contaminants with enhanced purification of the feed gas.

In accordance with an embodiment, the method 100 further comprises subjecting the first treated gas to at least one of: a water scrubber or an air filter, for removing one or more contaminants from the first treated gas. The water scrubber refers to a chemical equipment that is used to remove particulates and/or gases from industrial exhaust streams. Moreover, the air filter refers to a device composed of fibrous, or porous materials, which removes solid particulates, such as dust, pollen, and bacteria from the air. In operation, the first treated gas obtained from the outlet of the first reactive space is received into the water scrubber. In an example, the first treated gas is brought into contact with a scrubbing liquid to remove the components dissolved therein. Notably, the scrubbing liquid, typically water or a water-based solution, is sprayed or introduced into the water scrubber. Typically, the scrubbing liquid acts as a scrubbing medium and interacts with the feed gas to capture and remove contaminants therefrom. In an implementation, the dissolvable components may include compounds such as nitrate (NO₃), sulfur trioxide (SO₃), sulfate (SO₄), oxide of metal contaminants, and so forth.

In an implementation, the method 100 employs the water scrubber and air filter for protecting downstream equipment and systems. In an example, by removing contaminants, the method 100 prevents the accumulation of harmful substances in pipelines, valves, or sensitive equipment, minimizing the risk of corrosion, fouling, or blockages.

It will be appreciated that the first treated gases include a lower concentration of the one or more contaminants present in the feed gas. In an example, the one or more contaminants are oxidized as shown below:

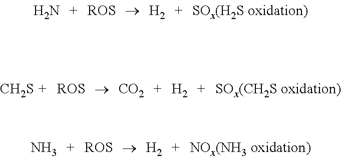

In accordance with an embodiment, the method 100 further comprises feeding the first treated gas obtained from the first reactive space into a second reactive space. The second reactive space refers to a process vessel that is used for carrying out a chemical reaction between the reactants under controlled conditions, such as a desired temperature, a desired pressure, a desired flow, and so forth. Moreover, the second reactive space is disposed after the first reactive space. Furthermore, the second reactive space enables the first treated gas to react in the presence of the light of the pre-defined wavelength and at least one reduction catalyst therein. In an implementation, by subjecting the first treated gas to the second reactive space, additional purification steps can be carried out, targeting specific compounds or contaminants that may have remained after the initial treatment. In an implementation, the method 100 employs the second reactive space to provide flexibility in adapting to different treatment requirements or varying feed gas compositions. In an implementation, the use of specific wavelengths of light and reduction catalysts in the second reactive space can promote targeted reactions and improve reaction rates. The use of specific wavelengths of light and reduction catalysts leads to increased process efficiency, reduced treatment time, and optimized resource utilization.

In accordance with an embodiment, the at least one reduction catalyst provided in the second reactive space is selected from at least one transition metal oxides of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide, a barium oxide, a lithium oxide, a calcium oxide, a potassium oxide, a magnesium oxide, a sodium oxide. The said reaction results in a production of a second treated gas. It will be appreciated that the second treated gas includes mainly N₂, CO₂, and O₂. In an implementation, the at least one reduction catalyst facilitates the effective reduction of pollutants present in the feed gas. Moreover, the at least one reduction catalyst promotes chemical reactions that convert harmful compounds into less toxic or inert forms, thereby mitigating environmental impact of the harmful compounds. The diverse range of reduction catalysts allows for tailored selection based on the specific pollutants to be targeted, resulting in optimized reduction efficiency. The at least one reduction catalyst demonstrates stability and durability under the operating conditions encountered, when in operation.

The method 100 is used for gas treatment and purification efficiently with reduced cost and energy consumption. The method 100 is used for the generation of the reactive oxygen species outside of the first reactive space. Moreover, the method 100 is used for reducing hazardous compounds, for example, oxides of nitrogen (NOₓ) to stable and less harmful products like nitrogen (N₂) and terminating the reaction of reactive oxygen species and producing the second treated gas.

The steps 102 to 108 are only illustrative, and other alternatives can also be provided where one or more steps are added, one or more steps are removed, or one or more steps are provided in a different sequence without departing from the scope of the claims herein.

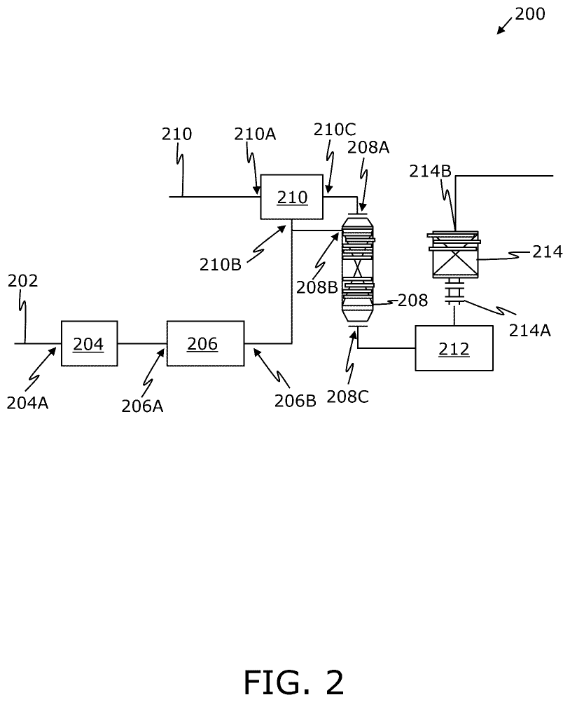

FIG. 2 is a schematic diagram of a system for gas treatment and purification, in accordance with an embodiment of the present disclosure. With reference to FIG. 2, there is shown a system 200 that comprises a supply arrangement 202, a voltage source 204, an oxidization chamber 206, and a first reactive space 208. There is further shown, a chamber 210, a water scrubber 212, and a second reactive space 214.

The supply arrangement 202 may be a gas cylinder, a gas well, or a network of pipelines to provide a continuous supply of the gas. The supply arrangement 202 is configured to provide a supply of gas including oxygen (O₂) gas. The supply arrangement 202 enables an efficient and improved control in the pressure of the gas, thereby allowing a safe and economical supply of the gas in the system 200.

The voltage source 204 is operatively coupled to the supply arrangement 202 to subject a defined voltage to the supply of gas including the oxygen (O₂) gas to generate ozone (O₃) gas. In other words, the voltage source 204 is communicably coupled with an inlet 204A that is configured to supply gas including oxygen (O₂) from the supply arrangement 202 thereof at one end and another inlet 206A that is configured to supply the ozone and/or gases including ozone into the oxidization chamber 206 at another end. In an example, the defined voltage is in a range from 34 kilovolts (kV) to 12 kilovolts (kV). In an operation, the defined voltage is used for converting the gas including oxygen (O₂) into ozone (O₃).

The oxidization chamber 206 is a hermetically sealed chamber. In this regard, the oxidization chamber 206 includes an inlet 206A that is configured to receive a supply of gas including ozone (O3) into the oxidization chamber 206. Moreover, the oxidization chamber 206 includes a light source configured to output the ultraviolet (UV) light of the pre-defined wavelength. In accordance with an embodiment, the light source is an ultraviolet lamp. In an implementation, the ultraviolet lamp may be placed in proximity to the inlet 206A that supplies gases including ozone (O₃) into the oxidization chamber 206 to achieve high mass transfer rates for efficient interaction and for high oxygen uptake at the liquid-gas interface. In accordance with an embodiment, the pre-defined wavelength of the ultraviolet (UV) light ranges from 10 nm to 400 nm. It will be appreciated that the pre-defined wavelength is chosen to optimize the energy absorption and activation of the ozone molecules, promoting the conversion of the ozone molecules into the reactive oxygen species.

The oxidization chamber 206 is used to convert O₂ to O₃ and the oxidization chamber 206 includes the at least one oxidation catalyst that refers to a catalyst, which causes oxidation reactions. In this regard, the oxidation catalyst enables the transfer of oxygen atoms, hydrogen atoms, or electrons, during the reaction. In an implementation, the combination of the pre-defined wavelength light and the oxidation catalyst creates an environment that promotes the efficient conversion of ozone into the reactive oxygen species.

In accordance with an embodiment, the at least one oxidation catalyst is selected from at least one transition metal oxides of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide. The technical effect of including the transition metal oxides as the at least one oxidation catalyst is to enhance the efficiency of the oxidation process within the oxidization chamber.

The reactive oxygen species refers to highly reactive chemicals formed from oxygen (O3). Typically, the reactive oxygen species operate via one-electron oxidation (e.g., radical ROS species) or two-electron oxidation (e.g., non-radical ROS species). In accordance with an embodiment, the reactive oxygen species is at least one of: a superoxide anion, a hydroxyl radical, a hydroxyl ion, a peroxyl radical, an alkoxyl radical, a hydroperoxyl radical, a perhydroxyl radical, a peroxide ion, a hydrogen peroxide, a singlet oxygen. Beneficially, the reactive oxygen species are generated, in a separate process, before feeding a feed gas into the first reactive space 208 to save operational costs and increase the efficiency of the system 200. Moreover, the oxidization chamber 206 comprises an outlet 206B. The said outlet 206B is configured to output the generated reactive oxygen species.

The first reactive space 208 refers to a process vessel that is used to carry out a chemical reaction under appropriate process variables. The first reactive space 208 is operatively coupled to the supply arrangement 202 through the oxidization chamber 206. In other words, the supply arrangement 202 is operatively coupled to the oxidization chamber 206 through the voltage source 204. Moreover, the oxidization chamber 206 is operatively coupled to the first reactive space 208. In accordance with an embodiment, the first reactive space 208 includes the light source configured to supply the ultraviolet (UV) light with a uniform distribution of light intensity in the first reactive space 208. Moreover, the first reactive space 208 includes a plurality of inlets 208A and 208B configured to receive the feed gas, and the generated reactive oxygen species therein. In an example, the feed gas includes compounds, such as volatile organic compounds (VOC), hydrocarbon compounds, sulfur compounds, and so forth, aimed for treatment and purification thereof. In accordance with an embodiment, the feed gas and the generated reactive oxygen species are separately fed via two different inlets of the plurality of inlets in the first reactive space 208. In an implementation, the feed gas aimed for treatment and purification is fed directly into the first reactive space 208. In this regard, the said arrangement prevents the feed gas and the generated reactive oxygen species from mixing prior to entering into the first reactive space 208. In accordance with an embodiment, the first reactive space 208 is a first reactor, such as the reaction of the feed gas and the generated reactive oxygen species in the presence of the light of a pre-defined wavelength and the at least one oxidation catalyst. Herein, the first reactor refers to a dedicated chamber or vessel designed to facilitate the reaction between the feed gas and the generated reactive oxygen species. In an implementation, the first reactor provides a controlled environment for the reaction to occur efficiently. It will be appreciated that the first reactor, the light of the pre-defined wavelength, and at least one oxidation catalyst work in conjunction with each other to provide an optimized environment for the reaction between the generated reactive oxygen species and the feed gas. The light energy promotes the activation of the generated reactive oxygen species, accelerating the oxidation reactions and improving the kinetics of the process. In another implementation, the first reactor, the light of the pre-defined wavelength, and at least one oxidation catalyst work in conjunction with each other to allow for the customization of the system 200 to address specific pollutant removal requirements. In accordance with an embodiment, the first reactor is a packed-bed reactor. Herein, the packed-bed reactor refers to a column or vessel filled with solid particles or catalysts.

The system 200 further comprises the chamber 210. The chamber 210 is disposed between the oxidization chamber 206 and the first reactive space 208. The chamber 210 includes a plurality of inlets 210A and 210B configured to receive the feed gas and the generated reactive oxygen species therein. In an implementation, the feed gas aimed for treatment and/or purification is passed through the chamber 210. Moreover, the chamber 210 is configured to cause the feed gas and the generated reactive oxygen species to contact with each other. In an implementation, the chamber 210 may include a static mixer to enable pre-contacting of the feed gas and the generated reactive oxygen species in order to allow thereof to react prior to feeding in the first reactive space 208. Furthermore, the chamber 210 comprises an outlet 210C configured to output a mixture of the feed gas and the generated reactive oxygen species. After that, the said mixture is received into the first reactive space 208 via the inlet 208A thereof. In an implementation, a catalytic reactor similar to the first reactive space 208 may be applied in parallel to the first reactive space 208 in order to increase the capacity of the first treated gas. In an implementation, the catalytic reactor similar to the first reactive space 208 may be applied in series to the first reactive space 208 in order to increase the cleanliness of the first treated gas.

Furthermore, the first reactive space 208 comprises a packed-bed reactor comprising the at least one oxidation catalyst of one or more transition metal oxides. Typically, the packed-bed reactor refers to a vessel packed with catalyst particles or pellets and a fluid that flows through the catalyst. The solid catalyst particles that are used to catalyze gas-liquid reactions in the first reactive space 208. Moreover, the said reactions take place on the surface of the at least one oxidation catalyst. Advantageously, the packed-bed reactor enables higher conversion of the reactant molecules per weight of the at least one oxidation catalyst than other reactive spaces. Notably, the at least one oxidation catalyst may be formed using a packing material fabricated using materials such as ceramic, metal, or glass. It will be appreciated that the at least one oxidizing catalyst is arranged in the packed-bed reactor to increase hydraulic retention time and interaction contact.

In operation, the first reactive space 208 enables bringing the feed gas and the generated reactive oxygen species into intimate contact with active sites on the at least one oxidation catalyst under appropriate process variables such as temperature, pressure, flow, the concentration of reactants, and so forth, for adequate time. Moreover, the rate of the reaction is proportional to the amount of the at least one oxidation catalyst, the reactants (e.g., the feed gas and the generated reactive oxygen species) contact, as well as concentrations of the reactants. Additionally, the ultraviolet light when combined with the reactive oxygen species may degrade the most persistent compounds present in the feed gas. In an example, the ultraviolet light may also act as a catalyst, thereby increasing the rate of the reaction in the first reactive space 208. The ultraviolet light enables effective disinfection of the feed gas by killing the unwanted components dissolved therein. The first reactive space 208 comprises an outlet 208C to output the first treated gas.

The system 200 further comprises at least one of: a water scrubber 212 or an air filter, for removing one or more contaminant from the first treated gas. The water scrubber 212 or the air filter is disposed between the first reactive space 208 and a second reactive space 214. The water scrubber 212 refers to a chemical equipment that is used to remove particulates and/or gases from industrial exhaust streams. In operation, the first treated gas obtained from the outlet 208C of the first reactive space 208 is received into the water scrubber 212. In an example, the first treated gas is brought into contact with a scrubbing liquid to remove the components dissolved therein. In an implementation, the dissolvable components may include compounds such as nitrate (NO₃), sulfur trioxide (SO₃), sulfate (SO₄), oxide of metal contaminants, and so forth.

In accordance with an embodiment, the system 200 further includes a second reactive space 214, such as a reduction reactive space. The second reactive space 214 includes an inlet 214A that is configured to feed the first treated gas obtained from the first reactive space 208. The second reactive space 214 includes the light source configured to supply the ultraviolet (UV) light of the pre-defined wavelength. Moreover, the second reactive space 214 comprises at least one reduction catalyst. The reduction catalysts refer to catalysts that cause reduction reactions. In this regard, the reduction catalysts reduce hazardous compounds, for example, oxides of nitrogen (NOₓ) to stable and less harmful products like Nitrogen (N₂) and terminate the reaction of the reactive oxygen species.

In accordance with an embodiment, the at least one reduction catalyst is selected from at least one of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide, a barium oxide, a lithium oxide, a calcium oxide, a potassium oxide, a magnesium oxide, a sodium oxide. In an operation, the first treated gas is caused to react in the second reactive space 214 in presence of the at least one reduction catalyst and UV light generated by the light source to produce a second treated gas. Moreover, the second reactive space 214 comprises an outlet 214B to output the second treated gas. In an implementation, the second treated gas may constitute compounds such as nitrogen (N2), carbon dioxide (CO₂), and oxygen (O₂).

The system 200 is used for gas treatment and purification efficiently with reduced cost and energy consumption. The system 200 is used for the generation of the ROS outside of the first reactive space. The system 200 is used for producing the first treated gas from the reaction of the feed gas and the reactive oxygen species. Therefore, the system 200 is used for reducing hazardous compounds, for example, oxides of nitrogen (NOₓ), and converting the hazardous compounds into stable and less harmful products, such as nitrogen (N₂) for terminating the reaction of ROS, and producing the second treated gas.

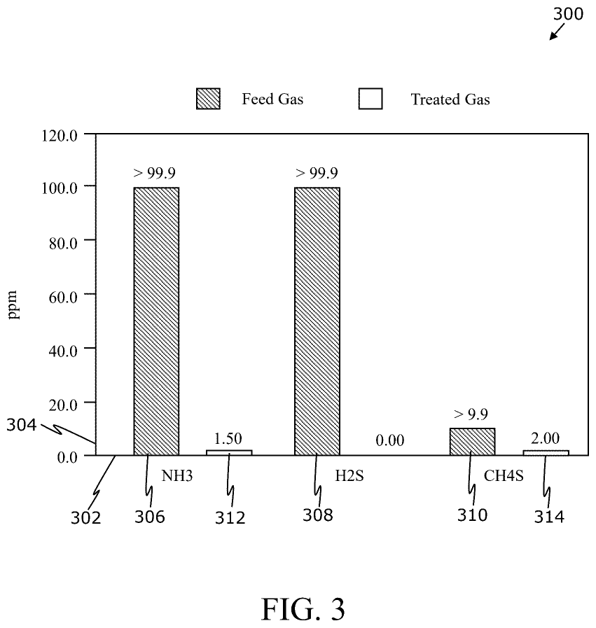

FIG. 3 depicts a graphical representation that illustrates measured values of the concentration of the chemical compounds present in a feed gas and a first treated gas, in accordance with an embodiment of the present disclosure. With reference to FIG. 3, there is shown a graphical representation 300 that includes an X-axis 302, representing chemical compounds present in the feed gas and the first treated gas, and a Y-axis 304, representing the concentration of the chemical compounds present in the feed gas and the first treated gas in ppm (parts per million).

With reference to the graphical representation 300, a first bar 306, a second bar 308, and a third bar 310 illustrate the concentration of the NH₃, the H2S, and the CH₄S present in the feed gas, respectively. As shown, the first bar 306 depicts that the concentration of the NH₃ in the feed gas is higher than 99.9 ppm (parts per million). Moreover, the second bar 308 depicts that the concentration of the H₂S in the feed gas is higher than 99.9 ppm (parts per million). In addition, the third bar 310 depicts that the concentration of the CH₄S in the feed gas is higher than 9.9 ppm (parts per million). With reference to the graphical representation 300, a fourth bar 312 and a fifth bar 314 illustrate the concentration of the NH₃ and the CH₄S present in the first treated gas, respectively. As shown, the fourth bar 312 depicts that the concentration of the NH₃ in the first treated gas is reduced to 1.50 ppm (parts per million). The fifth bar 314 depicts that the concentration of the CH₄S in the first treated gas is reduced to 2.00 ppm (parts per million). Beneficially, the first treated gas obtained after the treatment and purification includes zero ppm concentration of the H₂S gas.

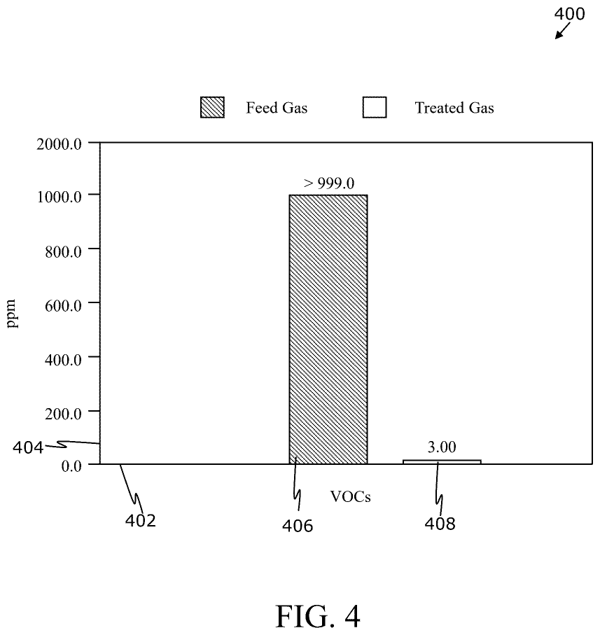

FIG. 4 depicts a graphical representation that illustrates measured values of the concentration of the volatile organic compounds (VOCs) present in a feed gas and a first treated gas, in accordance with an embodiment of the present disclosure. With reference to FIG. 4, there is shown a graphical representation 400 that includes an X-axis 402, representing the VOCs present in the feed gas and the first treated gas, and a Y-axis 404 that illustrates the concentration of the VOCs present in the feed gas and the first treated gas in ppm (parts per million).

With reference to the graphical representation 400, a first bar 406 illustrates the concentration of the VOCs present in the feed gas. As shown, the first bar 406 depicts that the concentration of the VOCs in the feed gas is higher than 999.0 ppm (parts per million). With reference to the graphical representation 400, a second bar 408 illustrates the concentration of the VOCs present in the first treated gas. The second bar 408 depicts that the concentration of the VOCs present in the first treated gas is 3.00 ppm (parts per million).

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the invention, which are, for brevity, described in the context of a single embodiment, may also be provided separately or in any suitable combination or as suitable in any other described embodiment of the disclosure.

1. A method (100) for gas treatment and purification, comprising:
generating ozone from a supply of gas comprising an oxygen (O₂) gas in presence of a defined voltage;
oxidizing the ozone (O₃), in an oxidization chamber (206), in presence of light of a pre-defined wavelength and at least one oxidation catalyst to generate reactive oxygen species (ROS);
feeding, in a first reactive space (208), the generated reactive oxygen species and a feed gas that is to be treated and purified; and
producing, from the first reactive space, a first treated gas from a reaction of the feed gas and the generated reactive oxygen species.

2. The method (100) according to claim 1, wherein the first reactive space is a first reactor, and wherein the reaction of the feed gas and the generated reactive oxygen species is in presence of light of a pre-defined wavelength and at least one oxidation catalyst.

3. The method (100) according to claim 1, further comprising pre-contacting the feed gas and the generated reactive oxygen species in a chamber (210) prior to the feeding of the feed gas and the generated reactive oxygen species in the first reactive space (208), wherein the chamber is disposed between the oxidization chamber (206) and the first reactive space.

4. The method (100) according to claim 1, wherein the feed gas and the generated reactive oxygen species are separately fed via two different inlets (208A, 208B) in the first reactive space (208).

5. The method according to claim 2, wherein the first reactor is a packed-bed reactor.

6. The method (100) according to claim 1 or 2, wherein the at least one oxidation catalyst is arranged in a packed-bed reactor.

7. The method (100) according to claim 1 or 2, wherein the at least one oxidation catalyst is selected from at least one or more transition metal oxides of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, or a lead oxide.

8. The method (100) according to claim 1, wherein the reactive oxygen species is at least one of: a superoxide anion, a hydroxyl radical, a hydroxyl ion, a peroxyl radical, an alkoxyl radical, a hydroperoxyl radical, a perhydroxyl radical, a peroxide ion, a hydrogen peroxide, a singlet oxygen.

9. The method (100) according to claim 1, further comprising subjecting the first treated gas to at least one of: a water scrubber (212) or an air filter, for removing one or more contaminants from the first treated gas.

10. The method (100) according to claim 1, further comprising:
feeding the first treated gas obtained from the first reactive space (208) into a second reactive space (214), wherein the second reactive space is disposed after the first reactive space; and
producing a second treated gas from the second reactive space by causing the first treated gas to react in presence of the light of the pre-defined wavelength and at least one reduction catalyst in the second reactive space.

11. The method (100) according to claim 10, wherein the at least one reduction catalyst provided in the second reactive space (214) is selected from at least one of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide, a barium oxide, a lithium oxide, a calcium oxide, a potassium oxide, a magnesium oxide, a sodium oxide.

12. The method (100) according to claim 1 or 2, wherein the light of the pre-defined wavelength is an ultraviolet (UV) light.

13. A system (200) for gas treatment and purification, the system comprising:
a supply arrangement (202) to provide a supply of gas comprising an oxygen (O₂) gas;
a voltage source (204), operatively coupled to the supply arrangement, to subject a defined voltage to the supply of gas comprising the oxygen (O₂) gas to generate ozone (O₃);
an oxidization chamber (206) configured to oxidize the ozone to generate reactive oxygen species (ROS) in presence of ultraviolet (UV) light of a pre-defined wavelength and at least one oxidation catalyst; and
a first reactive space (208), operatively coupled to the supply arrangement through the oxidization chamber, is configured to receive a feed gas and the generated reactive oxygen species, and produce a first treated gas from a reaction of the feed gas and the generated reactive oxygen species.

14. The system (200) according to claim 13, wherein the first reactive space is a first reactor, and wherein the reaction of the feed gas and the generated reactive oxygen species is in presence of light of a pre-defined wavelength and at least one oxidation catalyst.

15. The system (200) according to claim 13, wherein the oxidization chamber (206) comprises:
an inlet (206A) configured to receive a supply of gas comprising ozone (O₃) into the oxidization chamber;
a light source configured to output the ultraviolet (UV) light of the pre-defined wavelength;
the at least one oxidation catalyst; and
an outlet (206B) configured to output the generated reactive oxygen species.

16. The system (200) according to claim 13 or 14, wherein the at least one oxidation catalyst is selected from at least one or more transition metal oxides of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, or a lead oxide.

17. The system (200) according to claim 13, wherein the reactive oxygen species is at least one of: a superoxide anion, a hydroxyl radical, a hydroxyl ion, a peroxyl radical, an alkoxyl radical, a hydroperoxyl radical, a perhydroxyl radical, a peroxide ion, a hydrogen peroxide, a singlet oxygen.

18. The system (200) according to claim 13, wherein the first reactive space (208) comprises:
a light source configured to supply the ultraviolet (UV) light in a uniform distribution of light intensity in the first reactive space;
a catalyst in a packed-bed reactor comprising the at least one oxidation catalyst of one or more transition metal oxides;
a plurality of inlets (208A, 208B) configured to receive the feed gas and the generated reactive oxygen species into the first reactor; and
an outlet (208C) to output the first treated gas.

19. The system (200) according to claim 13, wherein the feed gas and the generated reactive oxygen species are separately fed via two different inlets (208A, 208B) in the first reactor (208).

20. The system (200) according to claim 13, further comprising a chamber (210) disposed between the oxidization chamber (206) and the first reactive space (208), wherein the chamber is configured to cause the feed gas and the generated reactive oxygen species to contact with each other and react prior to the feeding of the feed gas and the generated reactive oxygen species into the first reactive space.

21. The system (200) according to claim 13, further comprising a second reactive space (214) that is a reduction reactor, wherein the second reactive space comprises:
an inlet (214A) configured to receive the first treated gas from the first reactive space (208);
a light source and at least one reduction catalyst, wherein a second treated gas is produced by causing the first treated gas to react in presence of the at least one reduction catalyst and UV light generated by the light source; and
an outlet (214B) configured to output the second treated gas from the second reactive space.

22. The system (200) according to claim 21, further comprising at least one of: a water scrubber (212) or an air filter, to remove one or more contaminants from the first treated gas, wherein the water scrubber or the air filter is disposed between the first reactive space (208) and the second reactive space (214).

23. The system (200) according to claim 21, wherein the at least one reduction catalyst is selected from at least one of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide, a barium oxide, a lithium oxide, a calcium oxide, a potassium oxide, a magnesium oxide, a sodium oxide.
